(19) United States
(12) Patent Application Publication
(10) Pub. No.: US 2025/0036101 A1
(43) Pub. Date: Jan. 30, 2025

(54) INFORMATION PROCESSING DEVICE, INFORMATION PROCESSING PROGRAM, AND MACHINE TOOL

(71) Applicant: DMG MORI CO., LTD., Nara (JP)

(72) Inventors: Hironari SAKAMOTO, NARA (JP); Yoji TSUKUI, HOKKAIDO (JP); Michihiko ITO, HOKKAIDO (JP)

(73) Assignee: DMG MORI CO., LTD., Nara (JP)

(21) Appl. No.: 18/716,155

(22) PCT Filed: Dec. 19, 2022
(86) PCT No.: PCT/JP2022/046575

§ 371 Date: Jun. 4, 2024

(30) Foreign Application Priority Data
Dec. 22, 2021 (JP) 2021-208245

(51) Int. Cl. G05B 19/408

(52) U.S. Cl. CPC G05B 19/4086

(57) ABSTRACT

One aspect of the present invention is an information processing device that generates a first NC program used in a machine tool. This information processing device includes: a first conversion unit that converts a second NC program into CL data; an interpretation unit that interprets the CL data; and a second conversion unit that converts the CL data into a first NC program so that the first NC program includes an additional code corresponding to starting point data included in the CL data.

### TECHNICAL FIELD

The present invention relates to a technique for generating NC programs used in machine tools.

### BACKGROUND ART

In the above technical field, PTL 1 discloses a technique for automatically optimizing the positioning path of CL (Cutter Location) data generated by CAM (Computer Aided Manufacturing).

### CITATION LIST

### Patent Literature

PTL 1: JP 6438023 B

### SUMMARY OF INVENTION

### Technical Problem

However, in the technique described in the above literature, CL data is generated not only in a format standardized by ISO (International Organization for Standardization) but also in a unique format that varies among CAM manufacturers.

For this reason, converting CL data into NC programs requires development of a unique post-processor for each different CAM device, which takes a huge amount of cost and time.

In addition, because various machine tools are available from machine tool manufacturers, it is difficult for CAM device distributors to develop a post-processor that can convert the CL data into an NC program incorporating various optional functions of each machine tool. Therefore, even if useful functions are implemented in a machine tool in CL data as in PTL 1, it is not possible to convert the CL data into an NC program that implements the useful functions, and only a general-purpose function is available.

### Solution to Problem

Therefore, the present invention provides an information processing device that generates a first NC program used in a machine tool, including: a first conversion unit that converts a second NC program into CL data; an interpretation unit that interprets the CL data; and a second conversion unit that converts the CL data into a first NC program so that the first NC program includes an additional code corresponding to starting point data included in the CL data.

The present invention provides devices, programs, systems, and methods, among others.

### Advantageous Effects of Invention

The present invention makes it possible to generate programs that can implement a performance of a machine such as a machine tool at a higher level.

### BRIEF DESCRIPTION OF DRAWINGS

FIG. 1 is a block diagram illustrating a configuration of an information processing device according to a first embodiment.

FIG. 2 illustrates a flow of processing from a CAM device to a machine tool.

FIG. 3 is a conceptual diagram illustrating an optimizing method of an NC program performed by an information processing device.

FIG. 4 illustrates a specific example of processing until optimization of an NC program.

FIG. 5 illustrates a specific example until optimization of an NC program according to Modification 1.

FIG. 6 illustrates a specific example until optimization of an NC program according to Modification 2.

FIG. 7 is a block diagram illustrating a configuration of an information processing device according to a second embodiment.

### DESCRIPTION OF EMBODIMENTS

Hereafter, an embodiment of the present invention is described in detail by way of example with reference to the drawings. However, the components described in the following examples are illustrative only, and the scope of the invention is not intended to be limited to them.

### First Embodiment

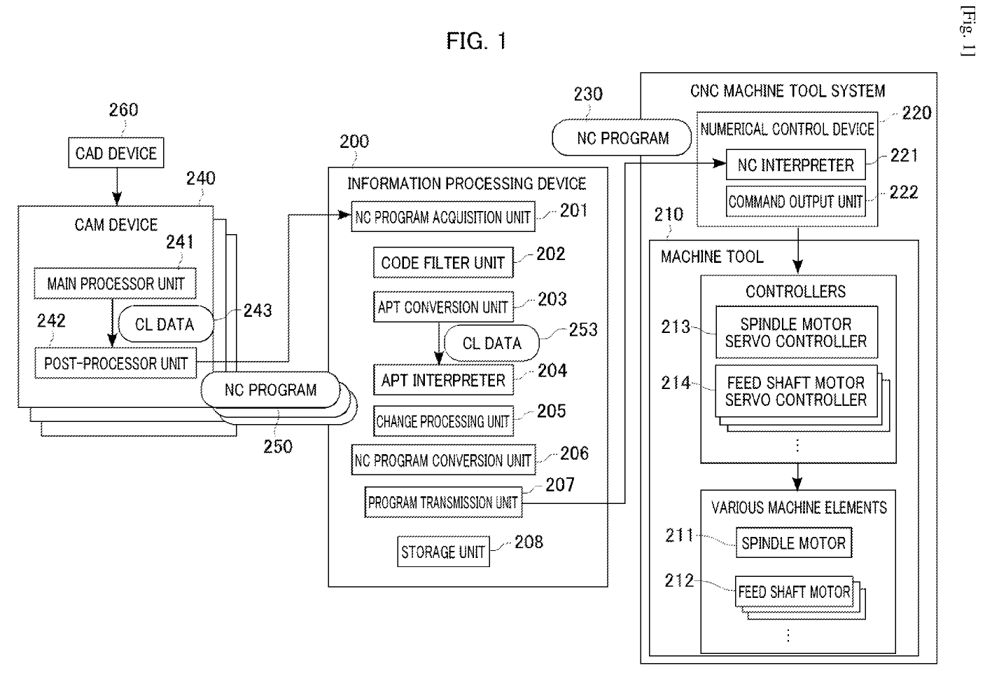

FIG. 1 is a block diagram illustrating a configuration of an information processing device according to a first embodiment.

An information processing device 200 is a device for generating an NC program 230 (first NC program) as a machining program used in a numerical control device 220. The numerical control device 220 numerically controls machining in a machine tool 210 and includes an NC interpreter 221 that interprets the NC program 230 and a command output unit 222 that outputs control commands to the machine tool 210.

Examples of the machine tool 210 include machine tools that process workpieces by additive manufacturing, machine tools that process workpieces by subtractive manufacturing, and machine tools that process workpieces by irradiating light such as lasers. Specifically, examples of the machine tool 210 may include a lathe, drilling machine, boring machine, milling machine, tooth cutter, grinder, multi-axis machine, laser machine, and laminating machine, which are numerically controlled according to an NC program and perform various machining such as turning, cutting, drilling, grinding, polishing, rolling, forging, folding, forming, micromachining, and laminating on workpieces such as metal, wood, stone, and resin. Furthermore, the machine tool may have a measuring function or be configured to measure dimensions of workpieces by using a measuring instrument such as a touch probe or camera.

The machine tool 210 is, e.g., a 3-axis machine and includes a spindle motor 211 and a feed shaft motor 212 as machine elements. The spindle motor 211 rotates the tool, and the feed shaft motor 212 moves the table linearly in the X- and Y-axis directions or the tool or table linearly in the Z-axis direction through ball screws or the like. The machine tool 210 may of course be a 5-axis machine.

A spindle motor servo controller 213 controls the spindle motor 211 on the basis of a control command from the command output unit 222. A feed shaft motor servo controller 214 controls the feed shaft motor 212 on the basis of a control command from the command output unit 222.

Each component of the information processing device 200 is implemented by hardware including computing units such as central processing units (CPUs) and various computer processors, a storage device such as memories and storages, and wired or wireless communication lines that connect these units and devices, and software that is stored in the storage devices and supplies processing instructions to the computing units. Computer programs may be constituted by device drivers, operating systems, various application programs on upper layers thereof, and a library that provides common functions to these programs. Each of the blocks, such as the code filter unit and the APT interpreter described below, represents a functional block.

The information processing device 200 includes an NC program acquisition unit 201, a code filter unit 202, an APT conversion unit 203, an APT interpreter 204, a change processing unit 205, an NC program conversion unit 206, a program transmission unit 207, and a storage unit 208.

The NC program acquisition unit 201 acquires an NC program 250 (second NC program) generated in a CAM (Computer Aided Manufacturing) device 240. The CAM device 240 has a main processor unit 241 and a post-processor unit 242. The main processor unit 241 generates CL data 243 on the basis of shape data acquired from a CAD (Computer-Aided Design) device 260. The post-processor unit 242 generates the NC program 250 from the CL data 243.

The storage unit 208 stores various program modules. A processor (not shown) implements the functions of each unit by executing various program modules. The storage unit 208 also stores a code list of non-standardized codes. After the code filter unit 202 removes at least part of the non-standardized code by referring to the code list, the reverse conversion to CL data (APT data) or the interpretation of CL data described later is performed. The “non-standardized code” may be non-ISO compliant code or code not based on the standardized information described below.

The code filter unit 202 retrieves, from the codes contained in the NC program 250, a list of codes not conforming to ISO 4343:2000 stored in the storage unit 208 and deletes them from the NC program. The standard codes defined in ISO 4343:2000 are codes for NC control such as shaft position and feed rate, and PLC (Programmable Logic Controller) control such as workpiece holding and coolant on/off. These are basic control commands that can be interpreted by any numerical control device. The code filter unit 202 functions as the “second interpretation unit” for interpreting the NC program 250.

The APT conversion unit 203 reversely converts the filtered NC program 250 into CL data 253 described with APT (Automatically Programmed Tools). Here, “filtering” means, as described above, removal of at least some of the non-standardized code. The APT conversion unit 203 functions as the “first conversion unit”. APT is a programming language developed for numerical control of machine tools, which can automatically specify tool paths and machining procedures on the basis of the shape of machine parts to be manufactured. Machining may use EXAPT (extended subset of APT) in which tool path determination function of APT is more precisely improved. Normally, conversion of APT to NC is generally performed in the post-processor, but the APT conversion unit 203 performs the reverse conversion of NC to APT. The code filter unit 202 may be included as a part of the APT conversion unit 203. In other words, the first conversion unit may filter the non-standardized code from the second NC program and convert the filtered second NC program to CL data.

The APT interpreter 204 interprets the reversely converted CL data 253, i.c., the CL data described by APT (hereinafter also referred to as “APT data”). The APT interpreter 204 functions as the “first interpretation unit” that interprets the CL data 253.

The change processing unit 205 performs optimization processing to the APT data. The change processing unit 205 executes at least one of the following on the APT data: deletion of unnecessary codes unnecessary for the machine tool 210 or the numerical control device 220, and addition of function codes that implement functions specific to the machine tool 210 or the numerical control device 220.

The NC program conversion unit 206 converts the CL data 253 (APT data) subjected to optimization processing into the NC program 230. The NC program conversion unit 206 functions as the “second conversion unit”. The program transmission unit 207 transmits the NC program 230 to the numerical control device 220.

Here, optimization processing is a concept that includes all processing that benefits machining, such as reducing machining time, improving machining accuracy, saving power and coolant, efficiently removing chips, improving efficiency through process control visualization, and measurement processing, among others. Specifically, optimization processing includes, but is not limited to, the following (1) to (4).

### (1) Optimization of Servo Characteristics

When machining modes such as (a) to (d) below are implemented by a custom macro, machining accuracy and machining time can be optimized by selecting the desired machining mode.
(a) Time priority mode: a mode that gives top priority to reducing machining time. This mode is used when required accuracy is low such as roughing.
(b) Middle mode: a mode that is intermediate between the time-first and accuracy priority modes. This mode is used for, e.g., medium finishing which requires high accuracy and short time.
(c) Accuracy priority mode: a mode that gives top priority to the improvement of machining accuracy. This mode is used when machining accuracy and finished surface are required.
(d) Accuracy top-priority mode: a mode that further prioritizes machining accuracy over the accuracy priority mode.

### (2) Automatic Optimization of Servo Characteristics

When a function for automatically adjusting the servo is implemented by a PLC, the mass and moment of inertia of the workpiece or jig are measured and the optimum acceleration/deceleration is set on the basis of the feedback value. Specifically, when the mass of the workpiece or jig is heavy and the moment of inertia is large, the acceleration/deceleration is suppressed to stabilize positioning. In contrast, when the mass of the workpiece or jig is light and the moment of inertia is small, the acceleration/deceleration is maximally increased to reduce the machining time.

### (3) Optimization of On/Off Control of Chip Conveyor

When the on/off function of a chip conveyor for discharging chips is implemented by a PLC, the volume of chips over time is calculated by machining simulation, and the on/off control of the chip conveyor is optimized according to the amount of chips. Specifically, during non-cutting or when the amount of chips is small, turning off the chip conveyor will save the driving power of the chip conveyor and improve the use efficiency of cutting oil.

### (4) Optimization of Process Control

When the function of tagging the same machining process with a common machining process ID is implemented among the NC viewers of the HMI of the CAM device, the information processing device, and the machine tool, the following functions can be implemented to optimize the process control.
A function to display or update changes in a subsequent process
A function to highlight changes when operating a machine tool
A function to stop at previous positioning command
A function to update the previous process with the changes, when only numerical values such as feed rate and spindle speed have been changed

The storage unit 208 stores program modules that implement the NC program acquisition unit 201, the APT conversion unit 203, the APT interpreter 204, the change processing unit 205, the NC program conversion unit 206, and the program transmission unit 207. In addition to the optimization processing information described above, the storage unit 208 stores a command table and machine tool information. Here, the command table is a table indicating the correspondence between commands and arguments in the standardized format and the commands of the NC program (NC codes). In this embodiment, a table indicating the correspondence between NC codes and CL data (APT data) is also stored.

Machine tool information is information about various machine tools of different machine tool manufacturers and models, such as machine origin, model stroke length, G code of machine specific instructions, and M code (Mxx, Mxy), and may also include the following information.
(1) Model number of machine tool
(2) Optional Information (number of turrets, spindle diameter, servo, type and presence/absence of chip conveyor, type and presence/absence of measuring device)
(3) Available tool types (e.g., drill and end mill)
(4) Number of pots and pot numbers in the magazine

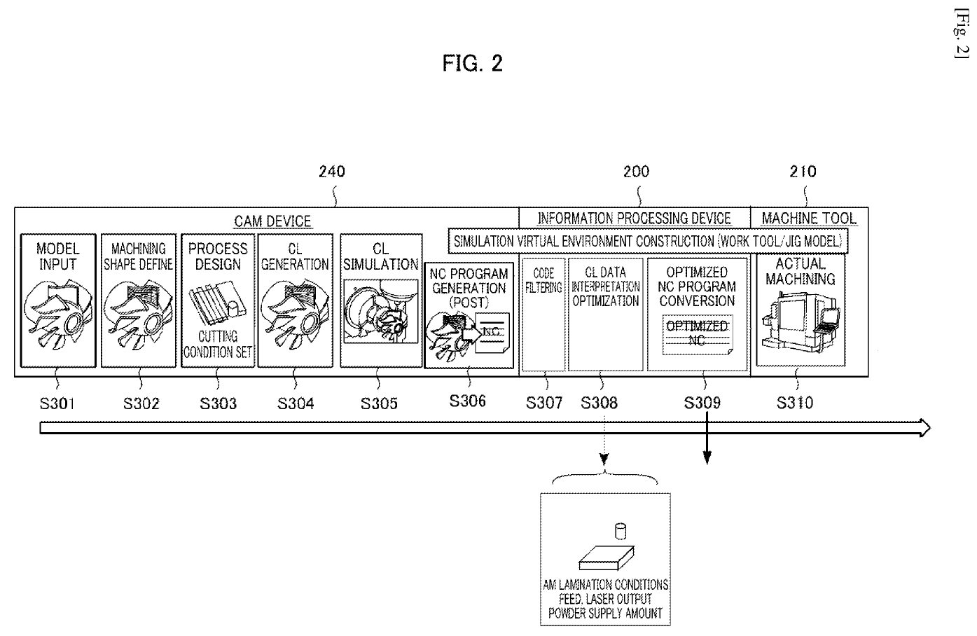

FIG. 2 illustrates a flow of processing from the CAM device 240 to the machine tool 210.

The CAM device 240 performs model input in step S301, defines machining shape in step S302, and performs process design (cutting condition setting) in step S303. Furthermore, in step S304, the CAM device 240 generates CL data on the basis of the process design. The CAM device 240 performs CL simulation in step S305 to confirm that no interference occurs in the tool path, and then generates the NC program 250 from the CL data 243 in step S306.

Next, the information processing device 200 filters and deletes the non-standardized codes in step S307, and then reversely converts the NC program 250 into CL data 253 (APT data) to interpret the CL data 253 and optimize the CL data 253 in step S308. This optimization of CL data 253 consequently corresponds to the optimization of the NC program.

Specifically, the information processing device 200 optimizes cutting force standardization and tool feed for cutting, and lamination conditions, stage feed, laser power, powder supply amount, and the like for AM (Additive Manufacturing), as well as measurement functions. In step S309, the information processing device 200 re-converts the CL data 253 after the optimization process into the NC program 230, thereby adding codes to the NC program 230 from the CAM device 240. Then, the machine tool 210 performs actual machining in step S310.

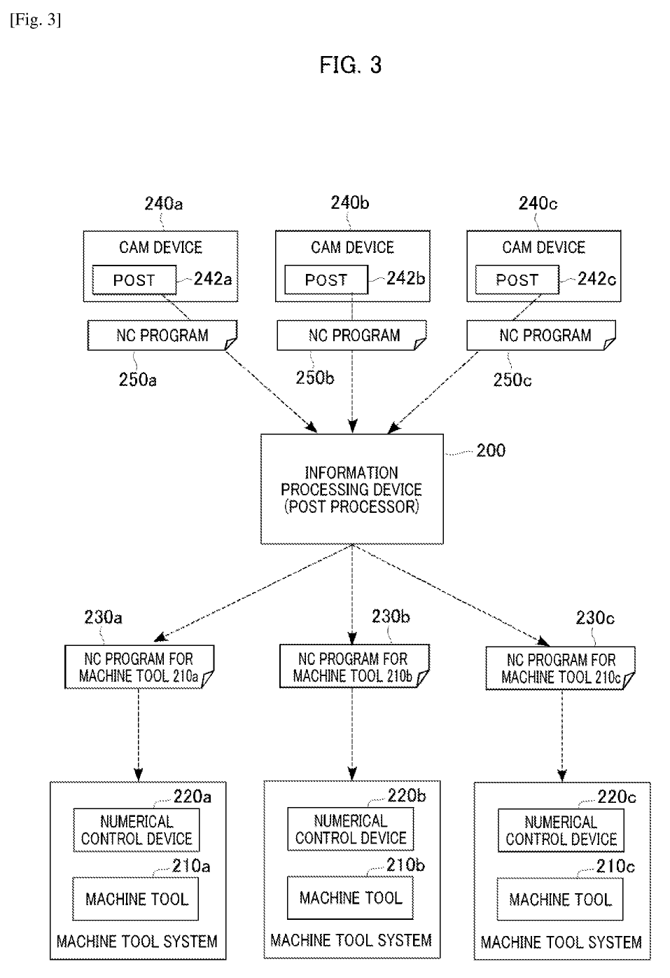

FIG. 3 is a conceptual diagram illustrating an optimizing method of an NC program performed by an information processing device 200.

As shown in this figure, it is assumed that several types of CAM devices 240a to 240c, each containing unique post-processor units 242a to 242c, output NC programs 250a to 250c converted from CL data 243. Even in such a case, the information processing device 200 (post-processor) reversely converts cach NC program 250a to 250c into CL data 253 (APT data), performs optimization processing, and then converts them into NC programs 230a to 230c corresponding to each numerical control device 220a to 220c of different machine tools 210a to 210c.

The numerical control device 220a may function as a “first numerical control device”, the numerical control device 220b may function as a “second numerical control device”, and the numerical control device 220c may function as a “third numerical control device”. Each numerical control device may contain mutually different command contents as command codes such as G codes. For example, commands executed by the second numerical control device and commands executed by the first numerical control device may be different codes.

When the CL data 243 output from the CAM device is information about a 3-axis machine, while the acquired machine tool information is information about a 5-axis machine, the information processing device 200 may output the NC program 230 for a 5-axis machine. In addition, when the CL data output from the CAM device does not include information about the machine tool such as the 3-axis machine or 5-axis machine, while the acquired machine tool information is information about a 5-axis machine, the information processing device 200 may output the NC program for a 5-axis machine. Generating NC programs on the basis of information about a machine tool in this way is also included in “optimization”.

This embodiment can automatically add optimization functions specific to machine tools and numerical control devices to the NC program without depending on the type of CAM device. This makes it possible to maximally utilize the functions of machine tools and numerical control devices. For example, it is possible to reduce machining time, improve surface quality, save power and coolant, efficiently remove chips, and improve efficiency by visualizing process control.

Although the code filter unit 202 of the present embodiment filters and deletes non-standardized codes, the present invention is not limited to this. The configuration may allow the user to select between the following two options. It is desirable that the G/M code filters can be edited by an operator.
OPTION 1. Codes are output as they are.
OPTION 2. Codes in the G/M code filter are removed.

For example, there are G codes common to all CAM devices such as G0, G1, G2, and G3 (defined by ISO), and the change processing unit 205 add optimization functions on the basis of such ISO-compliant G codes.

For each of the multiple types of non-standardized code, a setting unit may be further provided to set whether or not to remove the non-standardized code from the NC program. The code filter unit 202 may perform filtering of the NC program according to the settings in the setting unit.

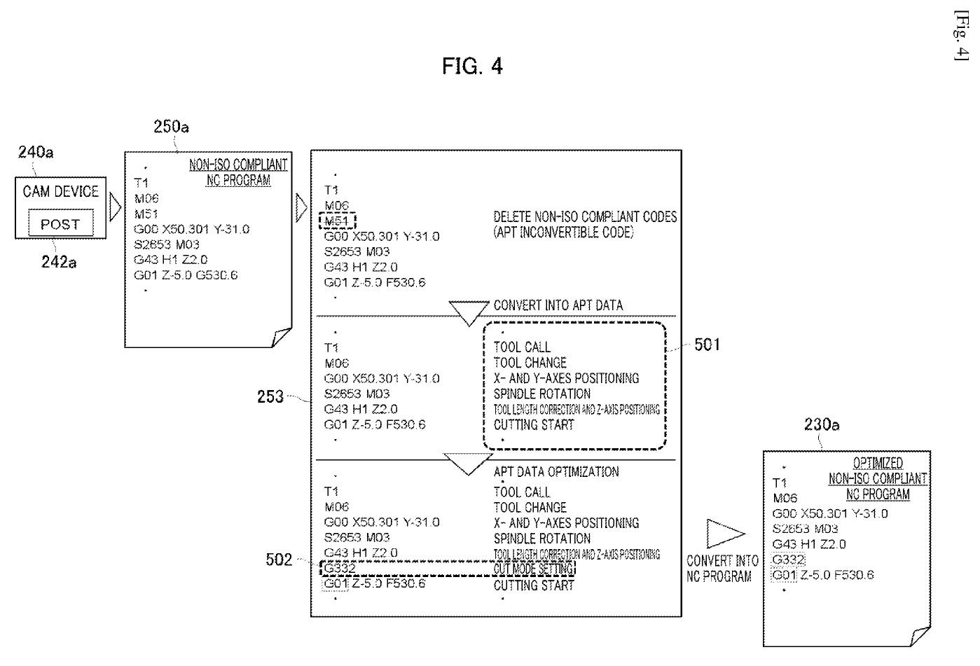

FIG. 4 illustrates a specific example of processing until the optimization of the NC program.

In this example, the NC program 250a is output from the post-processor unit 242a of the CAM device 240a. The code filter unit 202 deletes, from the NC program 250a, the non-ISO compliant code (non-standardized code), i.e., the code that cannot be reversely converted to APT data. In the illustrated example, M51 is shown. Non-ISO compliant G codes and M codes are recorded in the code list in advance. G codes and M codes not present in the code list are output as they are to the APT conversion unit 203.

The APT conversion unit 203 reversely converts the filtered NC program 250a into CL data 253 (APT data). The APT interpreter 204 adds an interpretation result 501 to the CL data 253. Note that the examples in this figure are only conceptual and do not mean that data is added as a Japanese text in this way.

The change processing unit 205 analyzes the interpretation result 501 and inserts a cutting mode setting code 502, i.c., G332 (an example of a first G code) just before the cutting start code G01 (an example of a second G code), thereby optimizing machining before starting cutting. It should be noted that the codes G01 and G332 may be the NC program code itself or the code corresponding part of the CL data corresponding to the NC program code.

G332 is a code for selecting the machining mode (cutting mode) of (a) to (d) described above. Specifically, any one of “G332R1”, “G332R2”, “G332R3”, or “G332R4” is inserted just before the cutting start code G01 in the NC program. The arguments R1 to R4 are set in the following cases.
R1: set for roughing (time priority mode)
R2: set for medium finishing (middle mode)
R3: set for finishing (accuracy priority mode)
R4: manually set by a user only when desired (accuracy top-priority mode)

For example, when OPTYPE/ROUGH (roughing) is set as an APT command in the APT data, the G code and argument of G332R1 is inserted. In the portions to be cut, the argument of G01 is set so that the feed rate decreases in the portion where the cutting force is high and increases in the portion where the cutting force is low. On the other hand, when OPTYPE/FINISH (finishing) is set as an APT command in the APT data, the G code and argument of G332R3 is inserted. In the portions to be cut, the argument of G01 is set so that the feed rate is constant.

The G332 is a code depending on the vendor of the numerical control device 220 (numerical control devices 220a to 220c) for implementing optimization conforming to the numerical control device 220. Specifically, the change processing unit 205 performs optimization processing by executing a predetermined script on the CL data 253 in APT format. Thus, G332 is inserted before G01. Then, the NC program conversion unit 206 converts the CL data 253 into the NC program 230 to generate the NC program 230 in which G332 is inserted before G01. As a result, the NC program 230a to which the machining conditions are added is output to the numerical control device 220.

In other words, the information processing device 200 performs processing to delete or ignore (comment out) the preset setting function code among the function codes whose function is not specified in ISO 6983-1:2009 or JIS B 6315-1:2013 from the program before processing. The information processing device 200 is further provided with an information processing unit that detects a starting point code (starting point data) as the starting point (also called an origin of point) among the multiple codes contained in the program before processing, performs processing to add an additional code corresponding to the starting point code, and generates processed program.

Examples of the codes the functions of which are specified in JIS B 6315-1:2013 include G00 to G04, G06, G09, M00 to M06, and M 10. In addition, M07 to M09 include codes defined by other standards such as ISO or the like, although no function is defined in JIS B 6315-1:2013. For example, M07 is noted by “sec, ISO/TR 6983-2”.

The examples of the codes the functions of which are not specified in JIS B 6315-1:2013 include G05, G07, G50 to G52, and G100 to G999. These G codes are numbered in JIS B 6315-1:2013, but the functions of them are described as un-specified. In addition, examples of the codes the functions of which are not specified in JIS B 6315-1:2013 include codes not described in JIS B 6315-1:2013, such as M51 and M59. An example of a starting point code is G01, and an additional code corresponding to G01 is G332, which is added before G01. It should be noted that, for convenience of explanation, CL data (APT data) corresponding to G01 of NC code is also denoted as starting point code G01 (starting point data) in this embodiment.

### Modifications

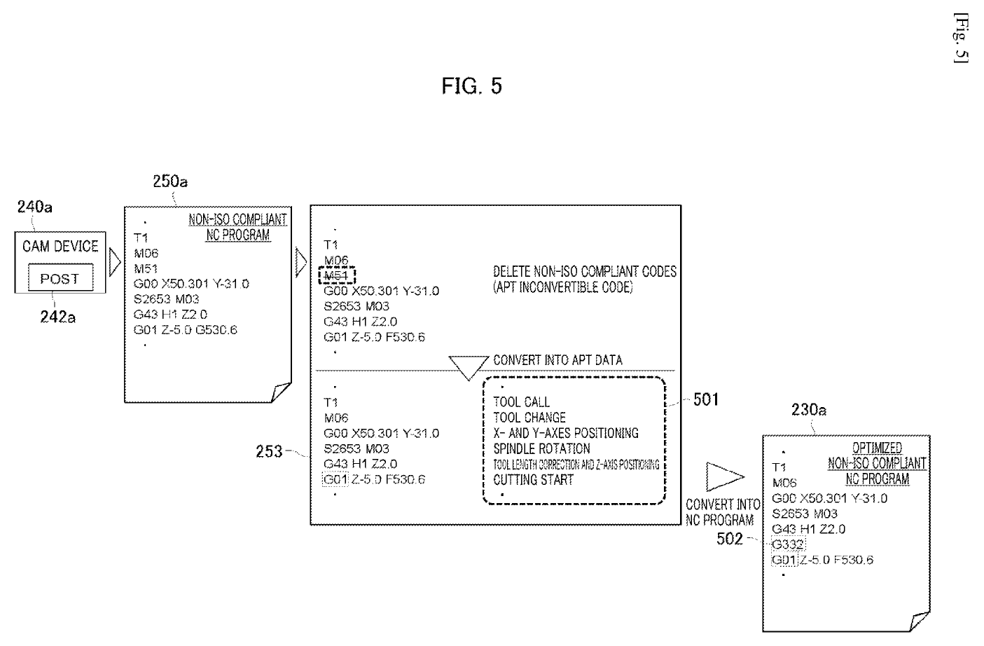

FIG. 5 illustrates a specific example until the optimization of the NC program according to Modification 1.

The above embodiment interprets the CL data 253 (APT data) obtained by reversely converting the NC program 250a (second NC program) to detect the starting point code G01, thereby optimizing the CL data 253 so that the CL data 253 includes an additional code G332 corresponding to the starting point code G01. The above embodiment illustrated an example in which the optimized CL data 253 is converted into the NC program 230a (first NC program).

In this modification, when the starting point code G01 is detected by interpreting the CL data 253 obtained by reversely converting the NC program 250a, no additional code is added to the CL data 253. Alternatively, the NC program conversion unit 206 incorporates an additional code G332 as the NC code when converting the CL data 253 into the NC program 230a. In this way, the NC program 230a can also be optimized.

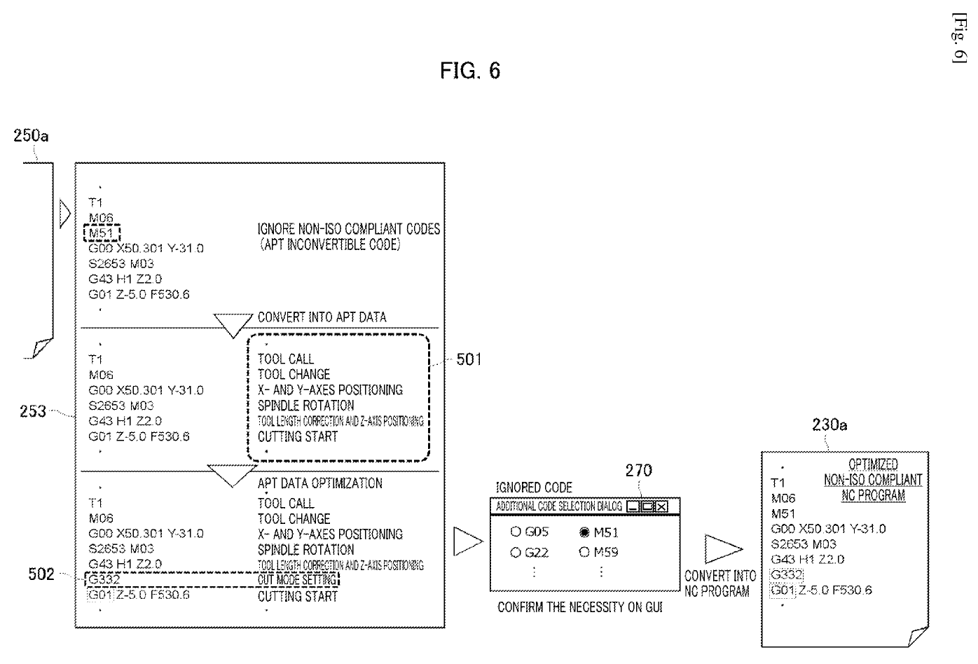

FIG. 6 illustrates a specific example until the optimization of the NC program according to Modification 2.

In the above embodiment, non-ISO compliant codes, i.c., codes that cannot be reversely converted to APT data, are deleted from NC program 250a (second NC program) and are not incorporated into NC program 230a (first NC program).

In this modification, when a non-ISO compliant code (a code that cannot be reverse converted to APT data) is detected in the NC program 250a, it is temporarily ignored (commented out). In other words, the “filtering” may be the deletion of a non-standardized code as in the above embodiment or may be the ignorance of a non-standardized code as in this modification. When the optimized CL data 253 is converted into the NC program 230a, a GUI screen is displayed to allow the user to select whether to incorporate the non-compliant code. The GUI screen can be displayed, c.g., as an additional code selection dialog 270 as shown in the figure, and codes which was ignored (ignored codes) can be selected.

When one of the ignored codes is selected by the user, the NC program conversion unit 206 incorporates the ignored code (M51 in the illustrated example) as the NC code when converting the CL data 253 into the NC program 230a. In this way, the NC program 230a can also be optimized.

### Second Embodiment

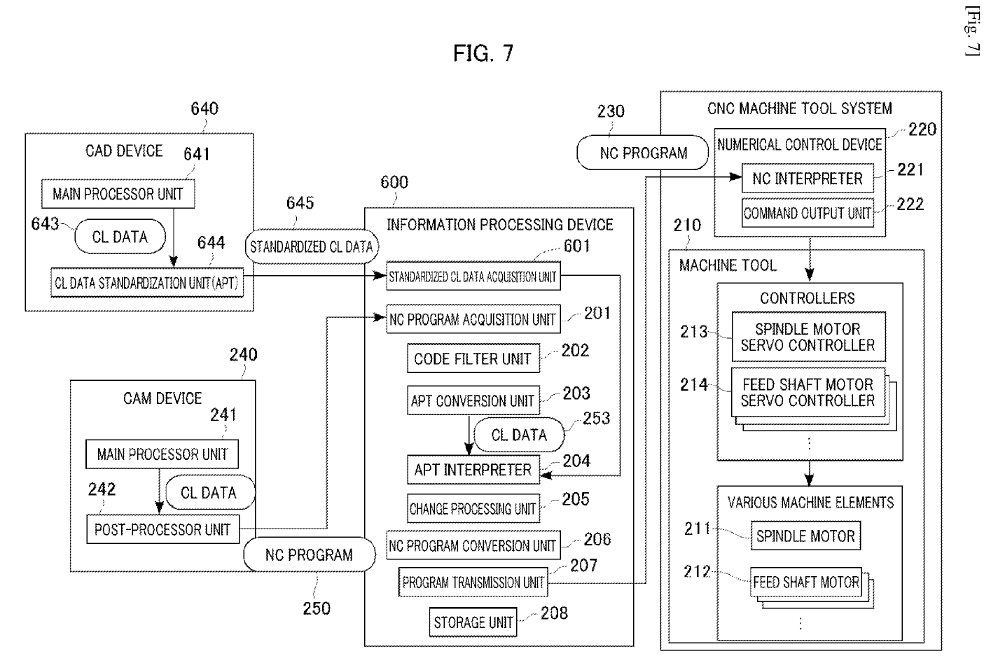

FIG. 7 is a block diagram illustrating a configuration of an information processing device according to a second embodiment.

The information processing device 600 differs from the first embodiment in having a standardized CL data acquisition unit 601. Since the other configurations and operations are the same as those of the first embodiment, the same configurations and operations are denoted by the same symbols and their descriptions are omitted. It should be noted that each component of the information processing device 600 may also be implemented by hardware including computing units such as processors, a storage device such as memories and storages, and wired or wireless communication lines that connect these units and devices, and software that is stored in the storage devices and supplies processing instructions to the computing units.

For a CAM device 640 that discloses the APT, a CL data standardization unit 644 can be incorporated that generates standardized CL data 645 by adding standardization information to CL data 643 output from a main processor unit 641. Here, the “standardized information” is information based on rules prescribed among multiple output devices such as CAM devices and numerical control devices. The CL data standardization unit 644 identifies CL data and specific control information such as machining and machines, and generates standardized CL data 645 labeled in a standardized format, which is standardized information corresponding to the specific control information. The specific control information is information such as custom macros and machining process information other than those defined in ISO 4343:2000.

Examples of the specific control information may include the followings.
(1) Drilling cycle pattern (c.g., CYCLE)
(2) Custom macros for machine tool users, e.g., a macro corresponding to the drilling cycle pattern (CYCLE) (such as G65P1000)
Here, the CL data is “CYCLE” and the NC code corresponding to this “CYCLE” is “G65P1000” or the like.

The standardized CL data acquisition unit 601 acquires standardized CL data 645. The APT interpreter 204 interprets the standardized CL data 645 (APT data) and detects the starting point code (c.g., CYCLE).

The NC program conversion unit 206 converts the standardized CL data 645 into the NC program 230 so that the NC program 230 includes an additional code (e.g., G65P1000) corresponding to the starting point code (e.g., CYCLE) detected by the APT interpreter 204. The program transmission unit 207 transmits the NC program 230 to the numerical control device 220.

When the NC program acquisition unit 201 acquires the NC program 250 including the non-standardized code from the CAM device 240, the information processing device 600 performs the same processing as in the first embodiment. That is, after the code filter unit 202 executes filtering for the NC program 250, the APT conversion unit 203 reversely converts the NC program 250 into CL data 253 (APT data). The APT interpreter 204 then interprets the CL data 253. The change processing unit 205 performs optimization processing on the CL data 253. The NC program conversion unit 206 converts the CL data 253 subjected to optimization processing into the NC program 230. The program transmission unit 207 transmits the NC program 230 to the numerical control device 220.

According to this embodiment, it is possible for the CAM device, which is the source of the NC program, to respond flexibly to both the case where the CL data (APT data) is disclosed and the case where it is not disclosed. Then, as in the first embodiment, this embodiment can automatically add optimization functions specific to machine tools and numerical control devices to the NC program without depending on the type of CAM device, thereby maximally utilizing the functions of machine tools and numerical control devices.

The present invention is not limited to the embodiments described above and modifications thereof, and any component thereof can be modified and embodied without departing from the scope of the invention. Components described in the embodiments and modifications can be combined as appropriate to form various embodiments. Some components may be omitted from the components presented in the embodiments and modifications.

In the above embodiments and modifications, examples are shown in which non-standardized codes are deleted from the NC program 250 acquired from the CAM device 240, and the NC program 250 after the deletion is reversely converted to CL data 253 (APT data). In a further modification, the NC program 250 acquired from the CAM device 240 may be reversely converted to CL data 253, and the codes that could not be reversely converted may be deleted as “non-standardized codes”. Specifically, after the APT conversion unit 203 reversely converts the NC program 250 into CL data 253, the APT interpreter 204 interprets the CL data 253 to identify the non-standardized codes that could not be reversely converted. Then, the code filter unit 202 may delete the non-standardized codes. The change processing unit 205 may perform optimization processing on the CL data 253 after deleting the non-standardized codes.

Although not described in the above embodiment, the information processing device only needs to have at least a first conversion unit (e.g., the APT conversion unit 203), an interpretation unit (e.g., the APT interpreter 204), and a second conversion unit (c.g., the NC program conversion unit 206). Then, the NC program is converted into CL data once, interpreted, and converted into the NC program so that the NC program includes the additional codes corresponding to the starting point data included in the CL data. The inclusion of that additional code allows for a higher level of performance for machines such as machine tools.

Although not described in the above embodiment, an information processing program using the above technology may be constructed. This program is an information processing program that generates a first NC program used in a machine tool, and enables a computer to implement: a first conversion function that converts a second NC program into CL data; an interpretation function that interprets the CL data; and a second conversion function that converts the CL data into a first NC program so that the first NC program includes an additional code corresponding to starting point data included in the CL data. The program may be recorded in and provided as a computer-readable recording medium.

This application claims priority from Japanese Patent Application No. 2021-208245 filed on Dec. 22, 2021, the entire contents of which are hereby incorporated by reference herein.

1. An information processing device that generates a first NC program used in a machine tool, the information processing device comprising:
a first conversion unit that converts a second NC program into CL data;
an interpretation unit that interprets the CL data; and
a second conversion unit that converts the CL data into a first NC program so that the first NC program includes an additional code corresponding to starting point data included in the CL data.

2. The information processing device according to claim 1, wherein the second conversion unit converts the CL data into the first NC program so that the first NC program includes, as the additional code, a second G code which (i) corresponds to the starting point data included in the CL data and associated with a first G code, and (ii) is executable by a given machine tool.

3. The information processing device according to claim 1, wherein the first conversion unit converts the second NC program into the CL data after filtering the second NC program to delete or ignore previously stored non-standardized codes among function codes the functions of which are not specified in ISO 6983-1:2009 or JIS B 6315-1:2013.

4. An information processing program that generates a first NC program used in a machine tool, the information processing program comprising:
a first conversion function that converts a second NC program into CL data;
an interpretation function that interprets the CL data; and
a second conversion function that converts the CL data into a first NC program so that the first NC program includes an additional code corresponding to starting point data included in the CL data.

5. A machine tool that performs machining by using a first NC program, the machine tool comprising:
a first conversion unit that converts a second NC program into CL data;
an interpretation unit that interprets the CL data; and
a second conversion unit that converts the CL data into a first NC program so that the first NC program includes an additional code corresponding to starting point data included in the CL data.
